(19) United States
(12) Patent Application Publication
(10) Pub. No.: US 2026/0296092 A1
(43) Pub. Date: Oct. 1, 2026

(54) SYSTEM AND DEVICE FOR PRINTING UPON TEXTURED SURFACES OF BUILDING PANELS, AND METHODS THEREOF

(71) Applicant: ARMSTRONG WORLD INDUSTRIES, INC., Lancaster, PA (US)

(72) Inventors: Steven L. MASIA, Lancaster, PA (US); Michelle X. WANG, Lititz, PA (US); Phi-Oanh R. PHAM, Lancaster, PA (US)

(73) Assignee: ARMSTRONG WORLD INDUSTRIES, INC., Lancaster, PA (US)

(21) Appl. No.: 19/688,639

(22) Filed: May 27, 2026

Related U.S. Application Data
(62) Division of application No. 17/825,101, filed on May 26, 2022.
(60) Provisional application No. 63/193,844, filed on May 27, 2021.

(51) Int. Cl. B44C 5/04; B41M 5/00; E04B 1/74

(52) U.S. Cl. CPC B44C 5/04; B41M 5/0047; E04B 1/74

(57) ABSTRACT

A system, device, and/or method for printing a three-dimensional effect on a surface of a building panel. The building panel is provided, wherein the building panel includes a first surface having a first plane. The building panel and a textured material associated with the building panel is provided to a printing device. The textured material may include one or more materials that protrude to a second plane beyond the first plane. The printing device includes one or more print heads. Ink is printed, via the one or more print heads, upon at least one of the surfaces of the building panel and the textured material. The one or more print heads may be positioned a distance from the surface of the building panel and the textured material so as not to contact the surface of the building panel and the textured material.

### CROSS-REFERENCE TO RELATED APPLICATIONS

This application is a divisional of U.S. Patent Application No. 17/825,101, filed May 26, 2022, which claims the benefit of U.S. Provisional Patent Application No. 63/193,844, filed May 27, 2021, the entire contents of which being hereby incorporated by reference herein, for all purposes.

### BACKGROUND OF THE INVENTION

Building panels are used to create interior surfaces, such as ceiling tiles, wall panels, and other partitions. Conventional building panels include acoustic panels that are flat and include an acoustic layer containing a combination of materials selected so as to provide adequate sound absorption while maintaining sufficient hardness. The flat profile of conventional building panels provides an image that is limited to two-dimensional effects. What is desired are building panels providing a look of three-dimensional effects, such as a look of concrete, stone, brick, wood, etc. What is further desired is a printing technique that can provide such three-dimensional effects on building panels.

### BRIEF SUMMARY OF THE INVENTION

A system, device, and/or method for printing a three-dimensional effect on a surface of a building panel. The building panel is provided, wherein the building panel includes a first surface having a first plane. The building panel and a textured material associated with the building panel is provided to a printing device. The textured material includes one or more materials that protrude to a second plane that is beyond the first plane. The printing device includes one or more print heads. Ink is printed, via the one or more print heads, upon at least one surface of the building panel and the textured material. The one or more print heads may be positioned a distance from the surface of the building panel and the textured material so as not to contact the surface of the building panel and the textured material. The building panel may be an acoustic panel. The three-dimensional effect may include a three-dimensional image of one or more of concrete, stone, brick, or wood. The textured material may be a fiberglass scrim, wood, metal, plastic, composite fiber, wood fiber, or the like.

One or more ends of the building panel may be shimmed via one or more shims. The shimming may maintain a predetermined gap between the building panel and a bed moving the building panel. The shimming of the one or more ends of the building panel may be removed (e.g., ceased) prior to the printing of the three-dimensional effect on the surface of the building panel. Ink may be printed upon both the surface of the building panel and the textured material. The printing of the ink may include spraying a coating of under ten grams per square foot of ink. For example, the printing of the ink may include spraying a coating of under three grams per square foot of ink. The spray may include a binding material, such as an organic binding material. The organic binding material may include at least one of polyethylene, polypropylene, polyvinyl pyrrollidone, or hemicellulose.

### BRIEF DESCRIPTION OF THE DRAWINGS

The present invention will become more fully understood from the detailed description and the accompanying drawings, wherein:

FIG. 1 is top perspective view of an example building panel, as described herein;

FIG. 2 is top perspective view of an example building panel providing three-dimensional effects, as described herein;

FIG. 3 is a cross-sectional view of the building panel as provided in FIG. 2;

FIG. 4 is a ceiling system comprising the building panel providing three-dimensional effects, as described herein.

FIG. 5 is a perspective view of an example printing system providing the three-dimensional effects of the example building panel, as described herein;

FIG. 6A is a plan view of components of the example printing system of FIG. 5;

FIG. 6B is a side view of components of the example printing system of FIG. 5; and

FIG. 7 is an example method of printing three-dimensional effects on building panels having textured surfaces, as described herein.

### DETAILED DESCRIPTION OF THE INVENTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/- 5% of the reference value. According to the present application, the term “substantially free” less than about 0.1 wt. % based on the total of the referenced value.

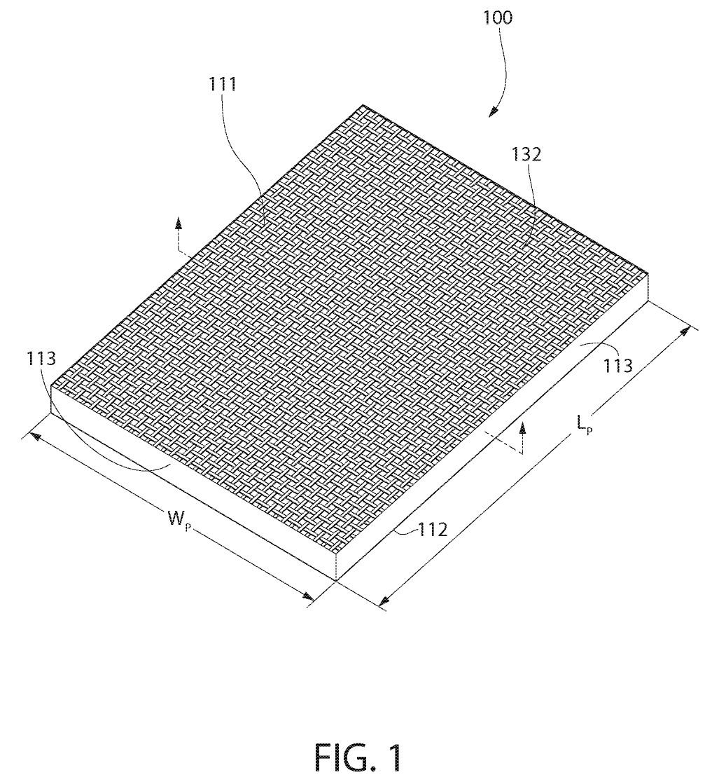

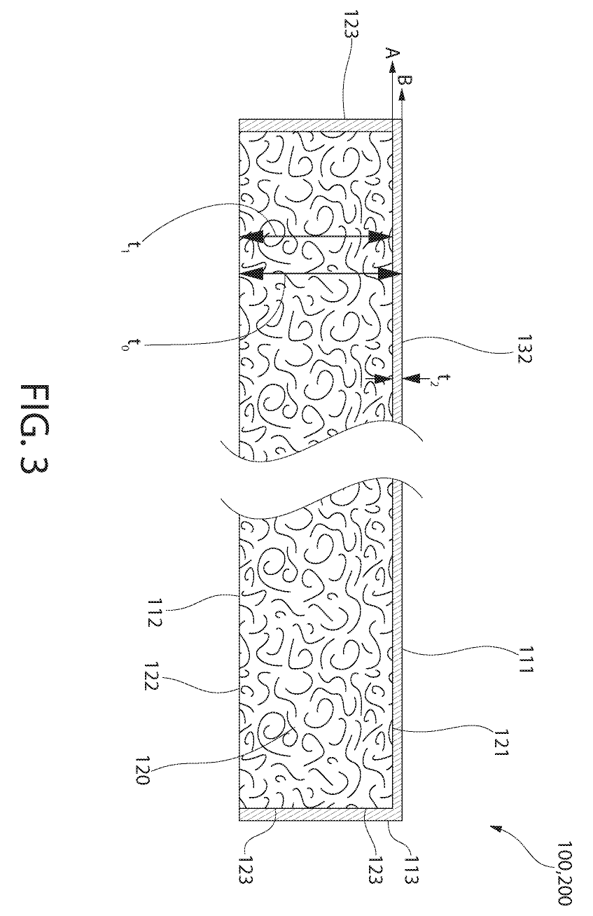

Referring to the figures, FIGS. 1-3 show views of an example building panel 100 used to show three-dimensional effects, as described herein. The building panel 100 includes a first major surface 111 opposite a second major surface 112 and a side surface 113 that extends between the first major surface 111 and the second major surface 112, thereby defining a perimeter of the panel 100. The first major surface 111 may define a plane (FIG. 3). The first major surface 111 may include the textured material. The plane of the first major surface 111 may run for the entire length L_{P} of the first surface 111 and/or an entire width W_{P} of the first surface 111 or a portion of the first surface 111. The building panel 100 may have a panel thickness ₜ₀ as measured from the first major surface 111 to the second major surface 112.

The building panel 100 may include a textured material 132. The textured material 132 may be a part of the building panel 100, although in examples the textured material 132 may be a material separate from the building panel 100 and coupled to the building panel 100. The textured material 132 may include any fibrous or non-fibrous materials that are textured. For example, as shown on FIG. 1, the building panel 100 may include textured material 132 in the form of a scrim (such as a fiberglass scrim, or mesh). The textured material may be one or more other materials, such as wood, metal, plastic, composite fiber, wood fiber, and the like. A non-limiting definition of the term scrim may refer to a fabric (e.g., cotton fabric) having an open construction used as a base fabric or a reinforcing fabric. The scrim may be coupled (e.g., wrapped) to building panel 100. The scrim may be embedded on and/or in a surface of the panel 100 (e.g., embedded on the upper surface 121 of the panel 100 to define a first surface 111 of the panel 100) and/or wrapped about one or more surfaces of the building panel 100. The scrim may be wrapped in mesh design (FIG. 1) and/or may extend to one or more edges of the building panel 100. One or more layers of scrim may overlap one or more portions and/or layers of one or more scrims. The edges of the building panel 100, and/or the end portions of the scrim may be wrapped to produce rounded edge corners.

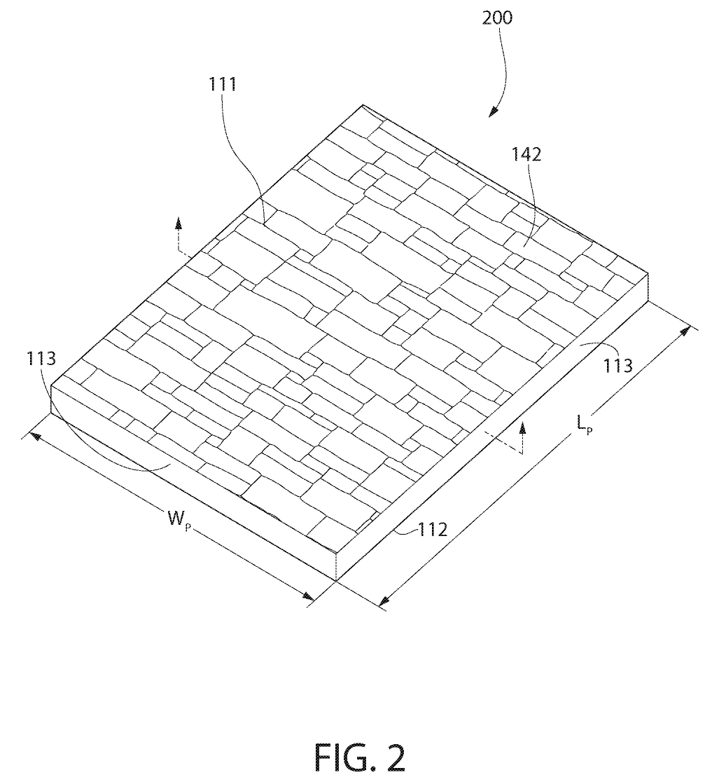

FIG. 2 shows a building panel 200 after printing a three-dimensional effect 142 upon the first surface 111 of the panel 100 (FIG. 1) and/or the textured material 132, as described herein. The three-dimensional effect 142 shown on panel 200 may include an appearance of one or more of concrete, stone, brick, wood, a landscape (e.g., images of buildings, mountains, caves, rock, bridges, homes, water sources, greenery, etc.), a sky (e.g., images of a sky during the daytime and/or nighttime, images of clouds in the sky, images of sun in the sky, etc.), a skyline (e.g., images of a skyline of the city or the country, a skyline during sunrise/sundown, etc.), artwork (e.g., famous artwork, personalized artwork), images of persons, animals, and/or objects (e.g., historical images, images of celebrities, images of athletes, images of pets, etc.), marketing slogans, and the like.

Although the thee-dimensional effect 142 is shown on the entirety of the first surface 111, it should be understood that such example is for illustration purposes only. In other examples, the thee-dimensional effect 142 may be shown on all, or less than all, of one or more surfaces of panel 200, such as first major surface 111, second major surface 112, and/or side surface 113. The thee-dimensional effect 142 may result due to a printing upon the building panel 100 and/or the textured material 132. As many of the portions of panel 200 are similar to panel 100, the similar portions described in reference to FIG. 1 will not be described again for FIG. 2.

FIG. 3 shows a cross-sectional view of the building panel 100, 200, as shown on FIGS. 1 and 2. Building panel 100, 200 may be referred to as building panel 100, building panel 200, or building panel 100, 200. Building panel 100 is a building panel with a textured material, as described herein. Building panel 200 is a building panel with a printing upon textured material, as described herein. Building panel 100, 200 may comprise a body 120. The body 120 may include an upper surface 121 opposite a lower surface 122 and a body side surface 123 that extends between the upper surface 121 and the lower surface 122. The upper surface of panel may include (e.g., define) a first plane A. The body 120 may have a body thickness t₁ that extends from the upper surface 121 to the lower surface 122. The body 120 may be porous, thereby allowing airflow through the body 120 between the upper surface 121 and the lower surface 122.

As described herein, a textured material 132 may extend from the building panel 100 (e.g., upper surface 121 of building panel) resulting in a textured building panel. The textured building panel (e.g., building panel 100 and textured material 132) may extend to provide a textured panel thickness t₀.The textured material 132 may include (e.g., define) a second plane B. For example, the textured material 132 may extend from the upper surface 121 of panel 100, 200 to produce a first surface 111 defining second plane B. Second plane B, including textured material 132, may extend a textured material distance t₂beyond the upper surface 121 of the building panel 100. Although FIG. 3 shows the first plane and the second plane being straight and parallel to each other, in examples the first plane and/or the second plane may be completely or partially uneven, bumpy, straight, curved, skewed from each other, and the like.The textured material 132 may extend from the upper surface 121 and/or one or more other surfaces (such as body side surface 123).

The body 120 of building panel 100, 200 may include a binder and fibers. In some examples, the body 120 may include a filler and/or additive. Non-limiting examples of binder may include a starch-based polymer, polyvinyl alcohol (PVOH), a latex, polysaccharide polymers, cellulosic polymers, protein solution polymers an acrylic polymer, polymaleic anhydride, epoxy resins, or a combination of two or more thereof. Non-limiting examples of filler may include powders of calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate.

The fibers may be organic fibers, inorganic fibers, or a blend thereof. Non-limiting examples of inorganic fibers mineral wool (also referred to as slag wool), rock wool, stone wool, and glass fibers. Non-limiting examples of organic fiber include fiberglass, cellulosic fibers (e.g. paper fiber – such as newspaper, hemp fiber, jute fiber, flax fiber, wood fiber, or other natural fibers), polymer fibers (including polyester, polyethylene, aramid – i.e., aromatic polyamide, and/or polypropylene), protein fibers (e.g., sheep wool), and combinations thereof.

The body 120 may be porous, thereby allowing airflow through the body 120 between the upper surface 121 and the lower surface 122 of the panel body 120. The term porous may refer to the body 120 being porous enough to allow for enough airflow through the body 120 under atmospheric conditions for the body 120 and the resulting building panel to function as an acoustic building panel and corresponding ceiling system 1 or wall system to function as an acoustical ceiling system or acoustical wall system, which requires properties related to noise reduction and sound attenuation properties.

The body 120 may exhibit superior sound attenuation – which is a measure of the sound reduction between an active room environment 2 and a plenary space 3. The ASTM has developed test method E1414 to standardize the measurement of airborne sound attenuation between room environments 2 sharing a common plenary space 3. The rating derived from this measurement standard is known as the Ceiling Attenuation Class (CAC). Ceiling materials and systems having higher CAC values have a greater ability to reduce sound transmission through the plenary space 3 – i.e. sound attenuation function.

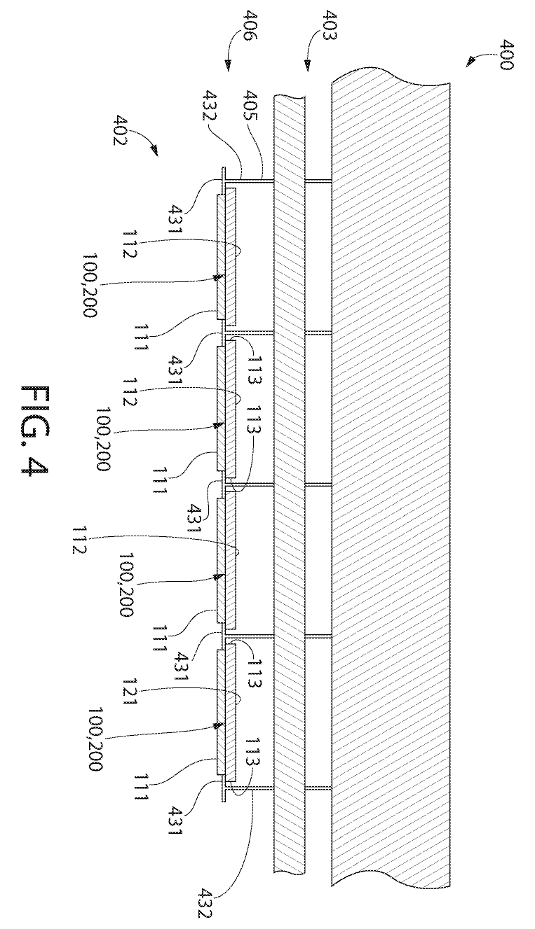

FIG. 4 shows an example ceiling system 400 comprising one or more of the building panels 100, 200 installed in an interior space, whereby the interior space comprises a plenum space 403 and an active room environment 402. The building panel 100, 200 may be positioned in one or more places within a room, such as on the ceiling of a room, on a wall of a room, on a floor of a room, and the like. The plenum space 403 may provide space for mechanical lines within a building (e.g., HVAC, plumbing, etc.). The active space 402 may provide room for the building occupants during normal intended use of the building (e.g., in an office building, the active space would be occupied by offices containing computers, lamps, etc.).

In the installed state, the building panels 100, 200 may be supported in the interior space by one or more parallel support struts 405. Each of the support struts 405 may include an inverted T-bar having a horizontal flange 431 and a vertical web 432. The ceiling system 400 may include a plurality of first struts that are substantially parallel to each other and a plurality of second struts that are substantially perpendicular to the first struts. In examples, the plurality of second struts may intersect the plurality of first struts to create an intersecting ceiling support grid 406. The plenum space 403 may exist above the ceiling support grid 406 and/or the active room environment 402 may exist below the ceiling support grid 406.

In the installed state, the first major surface 111 (including the textured material) of the building panel 100, 200 may face the active room environment 402 and the second major surface 112 of the building panel 100 may face the plenum space 403. Accordingly, the three-dimensional effects of the textured building panel may face the active room environment 402 in the installed state. The building panel 100 may be installed such that the horizontal flange 431 contacts the first major surface 111 of the building panel 100, 200, thereby vertically supporting the building panel 100, 200 in the ceiling system 400.

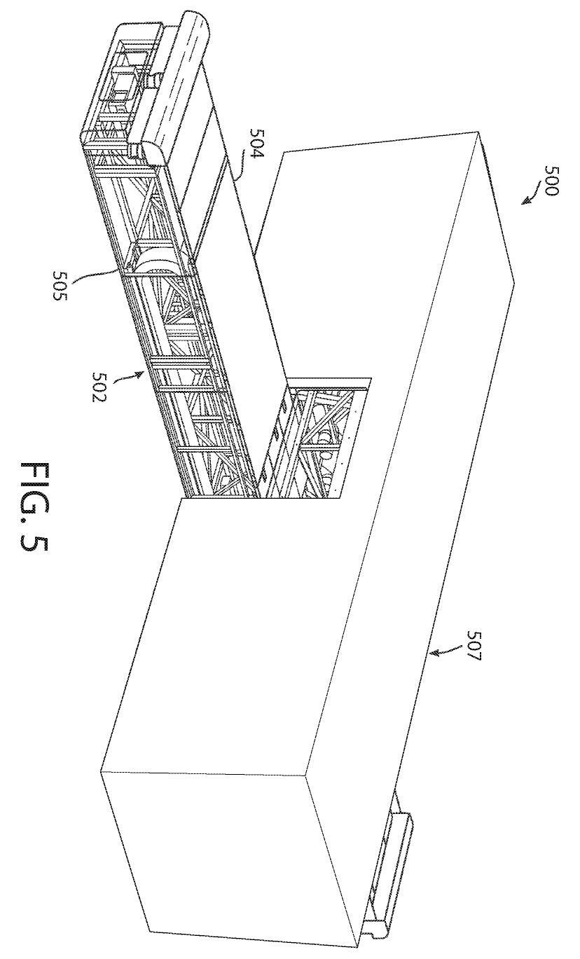

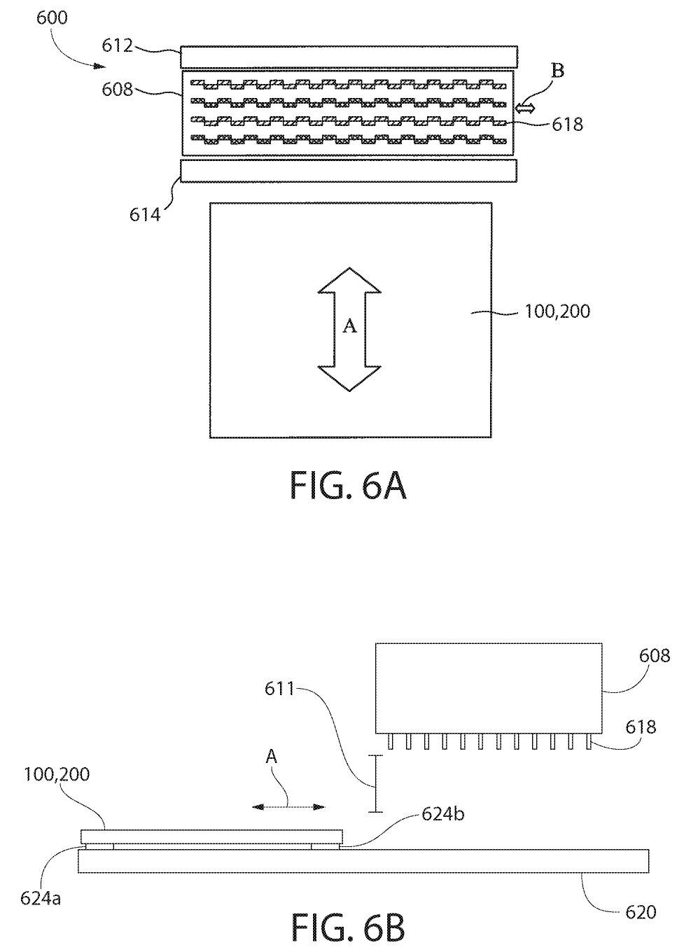

FIG. 5 shows a printing device 500 that may be used to print three-dimensional effects on a building panel (such as building panel 100 having a textured surface), as described herein. In examples printing device 500 may be an inkjet printer, a hybrid inkjet printer, and the like. The printer 500 may include a building panel table section 502 and/or a gantry section 507. The building panel table 502 may include a movable building panel table 504 for supporting building panel 100, 200. Printing device 500 may include a building panel table movement mechanism 505. The gantry section 507 may be arranged to support a print head carriage (such as print head cartridge 608). In use, building panel 100 may be placed (e.g., mounted) on the building panel table 504 for printing three-dimensional effects upon building panel 100. Printing the three-dimensional effects upon building panel 100 may include using print heads supported by print carriage 608 (FIG. 6A and FIG. 6B).

The gantry section 507 and/or the building panel table section 502 of printing device 500 may have a substantially rectangular footprint. A recess may be provided in a lower portion of the gantry section 507. The recess may be located in or near the center region of the gantry section 507. The building panel table section 504 may extend through the recess so that the gantry section 507 and/or the building panel table 502 are orthogonal to one another. The print carriage arrangement may be provided in the gantry section 507 in the region where the gantry section 507 and the building panel table section 504 intersect. As the building panel 100, 200 moves on the substrate table 504 and along the movement mechanism 505, the building panel 100, 200 may pass backwards and forwards in the recess in the gantry in the region of the print carriage arrangement and past the print heads.

FIG. 6A shows a schematic plan view including the example print head arrangement 600. As shown on FIG. 6A, the print carriage 608 may include one or more print heads 618. The building panel 100, 200 may move in the printing direction A under the print carriage 608 during printing to form an image on the building panel 100. The print heads 618 may move in direction B to print the image upon the building panel 100. The building panel 100 may move in the printing direction A one or more times to print the image and/or the print heads may move in direction B one or more times to print the image. Lamps, such as curing lamps 612 and 614 may be provided on one or more sides of the print carriage.

FIG. 6B shows a side view of the example printing arrangement showing the building panel 100, 200, print carriage 608, and print heads 618. A distance 611 between one or more of the print heads 618 and building panel 100 may be provided For example, the print heads 618 may be raised a distance (such as distance 611) so that the building panel 100, 200 (e.g., texture material 132 of building panel 100, 200) does not damage (e.g., mechanically damage) print heads 618. The print heads 618 may be positioned 0.06 inches above the surface (e.g., topmost surface) of the building panel 100, 200 and/or the surface (e.g., topmost surface) of the textured material 132. The print heads 618 may be positioned such that the print heads 618 remain at least 0.06 inches above the surface of the building panel 100, 200 and/or textured material 132 when traveling to print upon the building panel 100, 200 and/or textured material 132. It should be understood that such values are for illustration purposes only.

The distance from building panel 100 (e.g., textured material 132 of building panel 100) to print heads 618 may be reduced or increased. The increase in distance from building panel 100 (e.g., textured material 132 of building panel 100) to print heads 618 may be any value over the 0.06 inches. The distance between the print heads 618 and the building panel 100, 200 (e.g., textured material 132 of building panel 100) may be set to a value (e.g., predetermined value) that will prevent the textured material from contacting (e.g., damaging) the print heads 618. In examples, the predetermined distance between the print heads 618 and the building panel 100, 200 may be based on the printer used. In an example, the distance between the print heads 618 and the building panel 100, 200 (e.g., textured material 132 of building panel 100) may be at least 0.0125 inches.

To provide a predetermined distance between the print heads 618 and the building panel 100, 200 (e.g., textured material 132 on building panel 100, 200) one or more shims 624a, 624b (collectively referred to as shims 624) may be provided (e.g., coupled, adhered, etc.) to one or more (e.g., each) portions of the building panel 100, 200. For example, a shim 624a, 624b may be provided to one or more (e.g., each) ends of the building panel 100, 200. The shims 624 may be as wide as the building panel 100, 200 in examples, although in other examples the shims 624 may be thinner or wider than the building panel 100, 200. For example, one or more of the shims 624 may be at least 1 inch long. The shims 624 may be used to ensure that a predetermined and/or desired spacing (e.g., gap) is provided when placing the building panel 100, 200 onto bed 620 Bed 620 may hold and/or move building panel 100, 200 and/or textured material 132. Bed 620 may be a moving bed or fixed bed. In examples in which a fixed bed is used, a single shim 624 may be used (e.g., used at the initial position) where the print head 618 operates. One or more (e.g., all) of the shims 624 may be removed before printing upon the building panel 100. By removing the shims 624, the distance 611 between the building panel 100, 200 and/or textured material 132 and the print heads 618 may be maintained.

Material may be removed from the building panel 100, 200. For example, portions of the textured material 132, such as fibers of the textured material 132 or other materials poorly bound to the building panel 100, 200, may be removed. The material may be removed prior to the printing of the building panel 100, 200 and/or textured material 132. The material may be removed via a blowing of air and/or vacuuming of the surface(s) of the building panel 100, 200 and/or textured material 132.

After removing (e.g., via blowing of air and/or vacuuming) the material, a light coating of ink may be provided to (e.g., sprayed upon) the building panel 100, 200 and/or textured material 132. In example, no more than ten grams per square feet (e.g., under three grams per square foot) may be provided to building panel 100, 200 and/or textured material 132, for example, to prevent disruption of the textured material 132. The spray may include a polyethylene, polypropylene, polyvinyl pyrrollidone, hemicellulose, or other binders (e.g., organic binders). In examples the spray may include one or more of lime, sodium, potassium, lithium, and/or other silicates.

As described herein, the print heads 618 may be moved (e.g., raised) so that the print heads 618 are a distance away from building material 100, 200 and/or textured material 132 to prevent contact of one or more portions of building material 100 and/or textured material 132. For example, the print heads 618 may be moved (e.g., raised) so that the print heads 618 are a distance away from first plane (e.g. of building panel 100, 200) and/or second plane (of textured material 132), as described herein. The distance in which the print heads 618 are separated from the building panel 100, 200 and/or textured material 132 may reduce and/or eliminate splatter of ink when ink is applied to the building panel 100, 200 and/or textured material 132. In examples, the use of lamps (such as lamps 612, 614) may reduce or eliminate splatter of ink (e.g. uncured ink). The lamps may be high power lamps (such as ultraviolet lamps). In addition, or as an alternative to vacuuming, the print heads 618 may be cleaned according to a predetermined schedule.

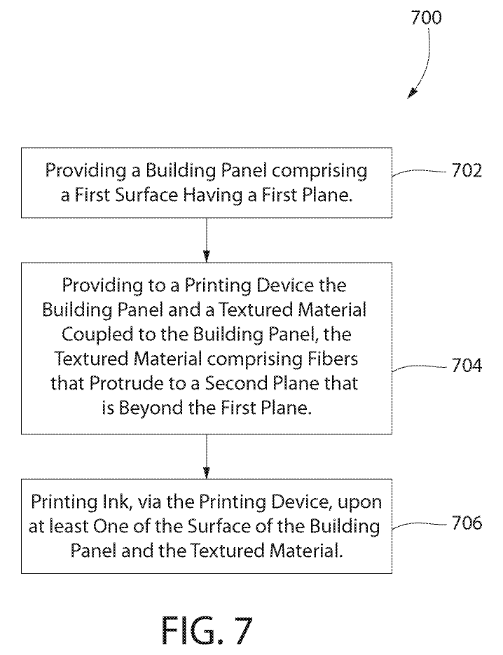

FIG. 7 shows an example process 700 for printing (e.g., printing three-dimensional effects) on one or more building panels. For example, the process may include printing concrete, brick, stone, wood, or other three-dimensional effects on building panels (e.g., acoustic panels) having a texture, as described herein. At 702, the building panel may be provided. The building panel may include a first surface having a first plane. A textured material may extend from the first surface to a second surface having a second plane. The second plane of the textured material may extend beyond the first plane of the first surface. The building panels may be formed of the textured material in examples, although in other examples the textured material may be added (e.g., coupled, adhered) to the building panels.

At 704, the building panel including the textured material may be provided to a printing device, such as printing device 500 described herein. At 704, the printing device may print upon the first plane of the first surface of the building panel and/or second surface of the textured material. The printing device may print one or more layers (e.g., layers of ink) on the building panels (e.g., textured building panels). The printing may include a printing value of at least 300 dots per square inch (“DPI”), although at least 600 DPI may be preferred. As described herein, the printing on the textured building panels may produce three-dimensional effects on the panels, such as concrete, stone, brick, wood, etc., effects. Ultra violet (“UV”) curable inks may be used to provide durable and/or realist images of the three-dimensional effects. High lamp intensity may be provided for printing.

In examples, when printing (e.g., digitally printing) upon the textured building panels, one or more print heads of the printer may be raised such that the texture does not mechanically damage the print heads. In an example, the print heads may travel at least 0.06 inches above the surface of the textured building panel. The print heads may travel above 0.06 inches at any height that may result in the print heads not touching one or more portions of the textured building panels, although in examples a head gap of .0125 inches may be provided.

A shim may be provided (e.g., adhered) to one or more (e.g., each) end of the building panel to be printed. The shim may be as wide as the building panel being printed. In examples, the shim may be at least 1 inches long. The shim may be used to ensure that the gap is correct when placing the building panel onto a moving bed of the printing device. The shim may be removed before printing. If a fixed bed is used for the printing device, one shim (e.g., only one shim) may be required, for example, at the initial position of where the print head operates. To print on a textured building panels with fibers or other material that are poorly bound to the, the surface of the building panels (e.g., fibers and/or other material on the surface of the building panels) must be vacuumed off the surface. After vacuuming, a coating (e.g., a light coating, such as no more than 10 grams/square foot or under 3 grams/square foot) may be sprayed, for example, to prevent disruption of texture. The spray may consist of a polyethylene, polypropylene, polyvinyl pyrrollidone, hemicellulose, or other safe organic binder or a combination of lime and sodium, potassium, lithium or other silicate. In examples, the print heads may be raised so that the print heads are far enough away from the textured building panels to prevent contact of the portions of the textured material that is out of plane of the building panel (e.g., acoustic panel) to be printed. Moving the print heads a predetermined distance and/or using UV lamps (e.g., the high power of the UV lamps) may prevent splash back of uncured ink. For example, as UV cured digital inks may be used for light fastness and durability it is desired that the ink does not spray back onto the print heads.

While the invention has been described with respect to specific examples including presently preferred modes of carrying out the invention, those skilled in the art will appreciate that there are numerous variations and permutations of the above described systems and techniques. It is to be understood that other embodiments may be utilized, and structural and functional modifications may be made without departing from the scope of the present invention. Thus, the spirit and scope of the invention should be construed broadly as set forth in the appended claims.

What is claimed is:

1. A method for printing a three-dimensional effect on a surface of a building panel comprising:
providing the building panel, wherein the building panel comprises the surface having a first plane;
providing, to a printing device, the building panel and a textured material associated with the building panel, wherein the printing device comprises one or more print heads and the textured material comprises one or more materials that protrude to a second plane that is beyond the first plane; and
printing ink, via the one or more print heads, upon at least one of the surface of the building panel and the textured material, wherein the one or more print heads are positioned a distance from the surface of the building panel and the textured material so as not to contact the surface of the building panel and the textured material.

2. The method of claim 1, wherein the building panel is an acoustic panel.

3. The method of claim 1, wherein the three-dimensional effect comprises a three-dimensional image of one or more of concrete, stone, brick, wood, a landscape, a sky, or an artwork.

4. The method of claim 1, wherein the one more materials of the textured material comprises one or more of a fiberglass scrim, wood, metal, plastic, composite fiber, wood fiber, or fabric.

5. The method of claim 1, further comprising vacuuming a portion of the texture material that is not bound to the building panel.

6. The method of claim 1, wherein the ink is an ultraviolet curable ink.

7. The method of claim 1, further comprising shimming one or more ends of the building panel, wherein the shimming maintains a predetermined gap between the building panel and a bed moving the building panel.

8. The method of claim 7, further comprising ceasing the shimming of the one or more ends of the building panel prior to the printing of the three-dimensional effect on the surface of the building panel.

9. The method of claim 1, further comprising printing the ink upon both the surface of the building panel and the textured material.

10. The method of claim 1, wherein the printing of the ink comprises spraying a coating of under ten grams per square foot of ink.

11. The method of claim 10, wherein the printing of the ink comprises spraying a coating of under three grams per square foot of ink.

12. The method of claim 10, wherein the spray comprises an organic binding material.

13. The method of claim 12, wherein the organic binding material comprises at least one of polyethylene, polypropylene, polyvinyl pyrrollidone, or hemicellulose.

14. The method of claim 10, wherein the printing of the ink flattens the textured material upon the building panel.

15. The method of claim 10, further comprising removing dust particles related to the textured material.

16. The method of claim 10, wherein the textured material is associated with the building panel via a coupling of the textured material to the building panel.

17. A method of printing a three-dimensional effect on a textured building panel, the method comprising:
providing the textured building panel on a bed of a printing device, the textured building panel comprising a textured material defining a panel body having an upper surface defining a first plane, the textured material comprising protruding portions extending beyond the first plane;
removing loose material from the textured material;
after removing the loose material, applying a sprayed coating to the textured material at a coating weight of no more than 10 g/ft²; and
printing, with one or more print heads of the printing device, an ultraviolet-curable ink onto the textured material to form the three-dimensional effect;
wherein, during printing, the one or more print heads are maintained at a distance from a topmost surface of the protruding portions such that the one or more print heads do not contact the textured material.

18. The method of claim 17, wherein removing the loose material comprises vacuuming the textured material, blowing air across the textured material, or both.

19. The method of claim 17, wherein the sprayed coating is applied at a coating weight of less than 3 g/ft².

20. The method of claim 17, further comprising positioning one or more shims at one or more ends of the textured building panel to establish a predetermined gap between the textured building panel and the bed of the printing device, and removing the one or more shims before the digitally printing.
